(19) United States
(12) Patent Application Publication
(10) Pub. No.: US 2005/0263091 A1
(43) Pub. Date: Dec. 1, 2005

(54) Door-attached pet enclosure apparatus

(76) Inventor: Brian Lee Knapp, Roland, OK (US)

Correspondence Address: S. Michael Bender, P.O. Box 530399, St. Petersburg, FL, 33747, US

(21) Appl. No.: 10/779,924

(22) Filed: Feb. 17, 2004

Related U.S. Application Data
(60) Provisional application No. 60/447,794, filed on Feb. 19, 2003.

(51) Int. Cl. A01K 1/035

(52) U.S. Cl. 119/484

(57) ABSTRACT

A door-attached pet enclosure apparatus includes a first housing portion attached to a door. A group of sidewall panels and a group of roof panels are retained in the first housing portion when the apparatus is in a folded-up, storage condition and are erected when the apparatus is in the extended, pet-enclosure condition. A second housing portion is attached to the first housing portion. Roof-to-sidewall securing means secure the roof panels to the sidewall panels when the apparatus is in an extended, pet-enclosure condition. When the apparatus is in the extended, pet-enclosure condition, the apparatus provides a pet enclosure. When used in conjunction with a conventional pet access portal in the door, the conventional pet access portal provides an access portal for entry of a pet into the pet enclosure and for exit of the pet from the pet enclosure to outside.

### CROSS-REFERENCE TO RELATED APPLICATION

This application claims priority based upon my copending Provisional Application Ser. No. 60/447,794; filed Feb. 19, 2003.

### BACKGROUND OF THE INVENTION

1. Field of the Invention

The present invention relates generally to pet enclosures, and, more particularly, to pet enclosures that can be used in conjunction with a small pet access door.

2. Description of the Prior Art

Indoor pet enclosures are well known. In addition, small pet access doors in vertical walls or doors of human habitations are well known for allowing easy movement of a pet back and forth from outside to inside the human habitation without the need for a human to open or close the pet access doors. In this respect, throughout the years, a number of innovations have been developed relating to pet enclosures that can be used in conjunction with a small pet access door, and the following U. S. patents are representative of some of those innovations: U.S. Pat. Nos. 5,261,350, 5,649,500, 6,029,609, and 6,394,035.

More specifically, each of U. S. Pat. Nos. 5,261,350, 5,649,500, and 6,394,035 discloses a pet enclosure used in conjunction with a small pet access door. However, in each of U. S. Pat. Nos. 5,261,350, 5,649,500, and 6,394,035, the pet enclosure more or less permanently extends out from the small pet access door into the human habitation. In this respect, the pet enclosure permanently occupies a considerable amount of space in the human habitation. There are times, however, when the pet enclosure is not needed. During such times, it would be desirable if a pet enclosure that is used in conjunction with a small pet access door could be folded up to occupy less space in the human habitation when the pet enclosure is not needed.

U. S. Pat. No. 6,029,609 discloses a pet enclosure that is used in conjunction with a small pet access door. The pet enclosure can be folded up against a door in the human habitation which contains the small pet access door. When the pet enclosure is folded up against the door of the human habitation, the small pet access door is blocked by the floor of the pet enclosure. It would be desirable, however, if a pet enclosure that is used in conjunction with a small pet access door could be folded up and still allow the small pet access door to remain open and accessible to the pet.

U. S. Pat. No. 5,975,017 may be of interest for its disclosure of a pet enclosure that is installed outside a human habitation and allows the pet access to the human habitation.

Still other features would be desirable in a door-attached pet enclosure apparatus. For example, to provide both a large pet enclosure volume when extended and a small volume when folded up, it would be desirable if a pet enclosure includes an extendable and retractable side walls and an extendable and retractable ceiling.

To assure that the pet enclosure in the extended condition remains securely in the extended condition, it would be desirable if a locking device is employed to lock the pet enclosure in the extended condition.

Also, to assure that the pet enclosure in the retracted condition remains securely in the retracted condition, it would be desirable if a locking device is employed to lock the pet enclosure in the retracted condition.

Thus, while the foregoing body of prior art indicates it to be well known to use pet enclosures in conjunction with small pet access doors, the prior art described above does not teach or suggest a door-attached pet enclosure apparatus which has the following combination of desirable features: (1) can be folded up to occupy less space in the human habitation when the pet enclosure is not needed; (2) provides a pet enclosure that is used in conjunction with a small pet access door that can be folded up and still allow the small pet access door to remain open and accessible to the pet; (3) provides a pet enclosure which includes extendable and retractable side walls and an extendable and retractable ceiling; (4) employs a locking device to lock the pet enclosure in the extended condition; and (5) employs a locking device to lock the pet enclosure in the retracted condition. The foregoing desired characteristics are provided by the unique door-attached pet enclosure apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a door-attached pet enclosure apparatus which includes a first housing portion attached to a door. A group of sidewall panels are retained in the first housing portion when the apparatus is in a folded-up, storage condition. Also, a group of roof panels are retained in the first housing portion when the apparatus is in the folded-up, storage condition. A second housing portion is attached to the first housing portion. Roof-to-sidewall securing means are provided for securing the roof panels to the sidewall panels when the apparatus is in an extended, pet-enclosure condition. When the apparatus is in the extended, pet-enclosure condition, the apparatus provides a pet enclosure. When used in conjunction with a conventional pet access portal in the door, the conventional pet access portal provides an access portal for entry of a pet into the pet enclosure and for exit of the pet from the pet enclosure to outside the house.

Preferably, the second housing portion is attached to the first housing portion with a housing-to-housing hinge. Preferably, the sidewall panels are connected to each other with sidewall-panel hinges. Preferably, the roof panels are connected to each other with roof-panel hinges.

Preferably, housing-to-housing lock means are provided for locking the first housing portion and the second housing portion together when the apparatus is in the folded-up, storage condition. The housing-to-housing lock means can include a first lock member attached to the first housing portion and a second lock member attached to the second housing portion. In addition, sidewall-to-sidewall locking means are provided for locking non-hinged ends of sidewall panels together.

Preferably, the door includes a pet access portal; the first housing portion includes a first housing access portal that is in registration with the pet access portal; and the second housing portion includes a second housing access portal that is in registration with the first housing access portal and the pet access portal when the apparatus is in a folded-up, storage condition.

Preferably, floor-mounted, portal cover gates are provided for covering the second housing access portal when the apparatus is in the extended, pet-enclosure condition.

Preferably, the roof-to-sidewall securing means include a lock bar. The lock bar is secured at a distal end to a lock loop attached to a distal roof panel.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved door-attached pet enclosure apparatus which has all of the advantages of the prior art and none of the disadvantages.

It is another object of the present invention to provide a new and improved door-attached pet enclosure apparatus which may be easily and efficiently manufactured and marketed.

It is a further object of the present invention to provide a new and improved door-attached pet enclosure apparatus which is of durable and reliable construction.

An even further object of the present invention is to provide a new and improved door-attached pet enclosure apparatus which is susceptible of a low cost of manufacture with regard to both materials and labor, and which accordingly is then susceptible of low prices of sale to the consuming public, thereby making such door-attached pet enclosure apparatus available to the buying public.

Still yet a further object of the present invention is to provide a new and improved door-attached pet enclosure apparatus which can be folded up to occupy less space in the human habitation when the pet enclosure is not needed.

Still another object of the present invention is to provide a new and improved door-attached pet enclosure apparatus that provides a pet enclosure that is used in conjunction with a small pet access door that can be folded up and still allow the small pet access door to remain open and accessible to the pet.

Yet another object of the present invention is to provide a new and improved door-attached pet enclosure apparatus which provides a pet enclosure which includes extendable and retractable side walls and an extendable and retractable ceiling.

Even another object of the present invention is to provide a new and improved door-attached pet enclosure apparatus that employs a locking device to lock the pet enclosure in the extended condition.

Still a further object of the present invention is to provide a new and improved door-attached pet enclosure apparatus which employs a locking device to lock the pet enclosure in the retracted condition.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a front perspective view showing a preferred embodiment of the door-attached pet enclosure apparatus of the invention attached to a door, wherein the apparatus is in a folded-up, storage condition.

FIG. 2 is a side view of the embodiment of the door-attached pet enclosure apparatus shown in FIG. 1 after the floor assembly of the apparatus has been lowered from the remainder of the apparatus.

FIG. 3 is a front view of the embodiment of the door-attached pet enclosure apparatus of FIG. 2 after one of the door gates has been unfolded to further complete the floor.

FIG. 4 is a side view of the embodiment of the invention shown in FIG. 3 after folding sidewalls have been unfolded and erected upon the floor assembly, after a folding roof has been unfolded and placed over the folding sidewalls, and after a lock bar has been installed to prevent a pet from lifting the roof or the sidewalls to get out from the apparatus.

FIG. 5 is a front view of the embodiment of the invention shown in FIG. 4, taken along line 5-5 thereof.

FIG. 6 is a top view of the embodiment of the invention shown in FIG. 5 taken along line 6-6 thereof.

### DESCRIPTION OF THE PREFERRED EMBODIMENT

With reference to the drawings, a new and improved door-attached pet enclosure apparatus embodying the principles and concepts of the present invention will be described.

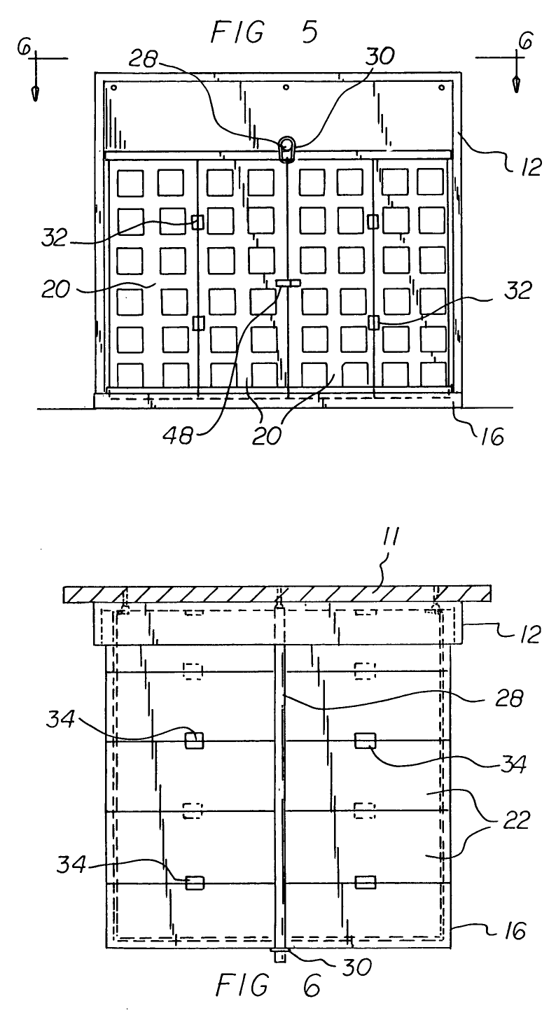

Turning to FIGS. 1-6, there is shown a preferred embodiment of the door-attached pet enclosure apparatus of the invention generally designated by reference numeral 10. In the preferred embodiment, door-attached pet enclosure apparatus 10 includes a first housing portion 12 attached to a door 11. A group of sidewall panels 20 are retained in the first housing portion 12 when the apparatus is in a folded-up, storage condition. Also, a group of roof panels 22 are retained in the first housing portion 12 when the apparatus is in the folded-up, storage condition. A second housing portion 16 is attached to the first housing portion 12. Roof-to-sidewall securing means are provided for securing the roof panels 22 to the sidewall panels 20 when the apparatus is in an extended, pet-enclosure condition.

Preferably, the second housing portion 16 is attached to the first housing portion 12 with a housing-to-housing hinge 42. Preferably, the sidewall panels 20 are connected to each other with sidewall-panel hinges 32. Preferably, the roof panels 22 are connected to each other with roof-panel hinges 34. Preferably, the sidewall panels 20 are in the form of open gridwork panels or fence-like panels.

Preferably, housing-to-housing lock means are provided for locking the first housing portion 12 and the second housing portion 16 together when the apparatus is in the folded-up, storage condition. The housing-to-housing lock means can include a first lock member 36 attached to the first housing portion 12 and a second lock member 38 attached to the second housing portion 16. The first lock member 36 and the second lock member 38 can include a sliding lock mechanism, similar to locks used on windows. In addition, sidewall-to-sidewall locking means are provided for locking non-hinged ends of sidewall panels 20 together.

Preferably, the door 11 includes a pet access portal 13; the first housing portion 12 includes a first housing access portal 14 that is in registration with the pet access portal 13; and the second housing portion 16 includes a second housing access portal 18 that is in registration with the first housing access portal 14 and the pet access portal 13 when the apparatus is in a folded-up, storage condition.

Preferably, floor-mounted, portal cover gates 40 are provided for covering the second housing access portal 18 when the apparatus is in the extended, pet-enclosure condition.

Preferably, the roof-to-sidewall securing means include a lock bar 28. The lock bar 28 is secured a one end adjacent to the door 11 and at the other end to a distal roof panel 22. The lock bar 28 is secured at a distal end to a lock loop 30 attached to a distal roof panel 22.

When the door-attached pet enclosure apparatus 10 of the invention is not is used to erect a pet enclosure, the apparatus is in retained in the folded-up, storage condition as shown in FIG. 1.

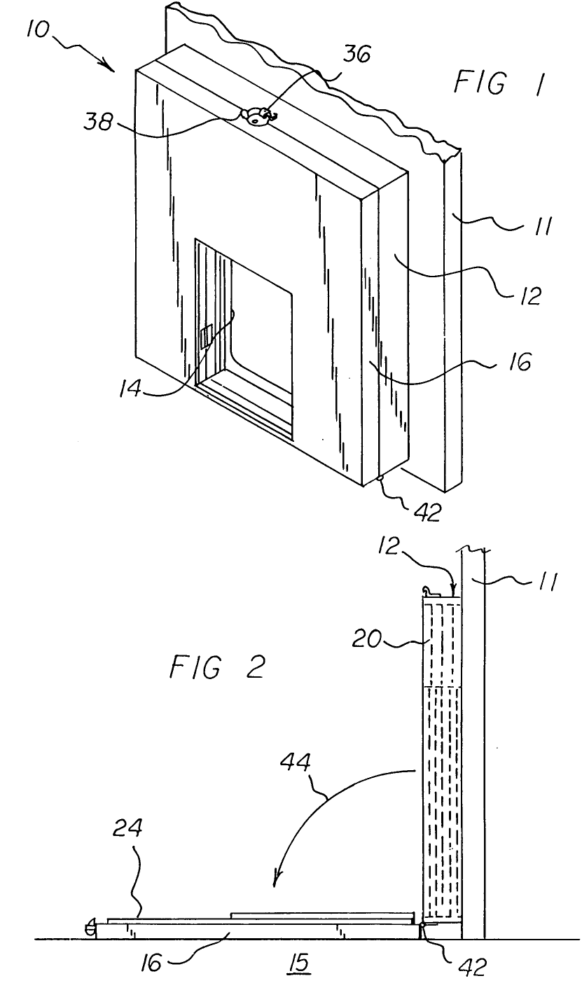

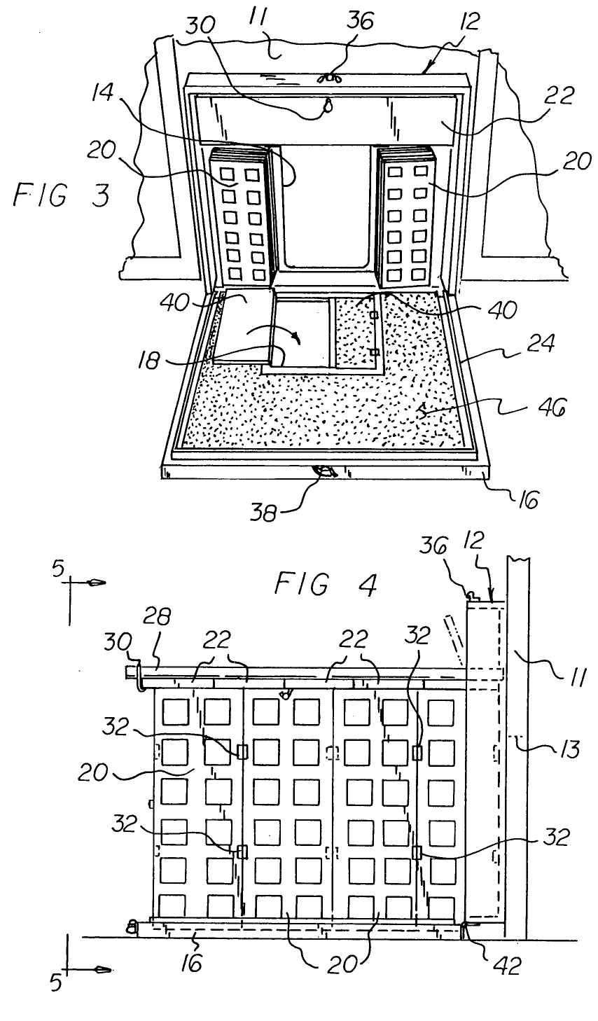

To use the door-attached pet enclosure apparatus 10 as a pet enclosure, the second lock member 38 is detached from the first lock member 36, and the second housing portion 16 is lowered to the floor 15 as shown by directional arrow 44 in FIG. 2. Then, as shown in FIG. 3, the portal cover gates 40 are positioned to fill up the second housing access portal 18, whereby a complete floor 46 is provided by the combination of the top surface of the second housing portion 16 and two portal cover gates 40.

Then, the sidewall panels 20 are removed from the first housing portion 12 and are unfolded around the sidewall-panel hinges 32. Then, the sidewall panels 20 are placed upon the tongue 24 which projects upward from the second housing portion 16. That is. Each sidewall panel 20 includes a sidewall bottom groove that fits onto the tongue 24. The sidewall panels 20 can be in two groups. A right group and a left group, which can be latched together with latch 48.

At this stage in assembly, the door-attached pet enclosure apparatus 10 of the invention provides a pet enclosure which includes three erected sidewalls 20, the door 11, and the floor 46. This form of the pet enclosure does not includes a roof. The conventional pet access portal 13 provides an access portal for entry of a pet into the pet enclosure and for exit of the pet from the pet enclosure to outside the house. Then, as shown in FIG. 4, the roof panels 22 are unfolded from their storage location in the first housing portion 12. The lock loop 30 can be pulled on to pull the roof panels 22 so that they unfold around the roof-panel hinges 34. Then, the lock bar 28 can be placed on top of the unfolded roof panels 22 to prevent the roof panels 22 from being lifted by a pet that is in the pet enclosure. The lock loop 30 can be wrapped around the distal end of the lock bar 28 to prevent the lock bar 28 from being removed from its locking position on top of the roof panels 22.

At this point in the assembly of the door-attached pet enclosure apparatus 10 of the invention, the assembly of the pet enclosure is complete to includes a roof covering the sidewalls.

When the door-attached pet enclosure apparatus 10 is no longer needed in the extended, pet-enclosure condition, the assembly steps can be reversed to provide disassembly steps, and the door-attached pet enclosure apparatus 10 can be returned to the folded-up, storage condition shown in FIG. 1.

The components of the door-attached pet enclosure apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved door-attached pet enclosure apparatus that is low in cost, relatively simple in design and operation, and which may advantageously can be folded up to occupy less space in the human habitation when the pet enclosure is not needed. With the invention, a door-attached pet enclosure apparatus provides a pet enclosure that is used in conjunction with a small pet access door that can be folded up and still allow the small pet access door to remain open and accessible to the pet. With the invention, a door-attached pet enclosure apparatus provides a pet enclosure which includes extendable and retractable side walls and an extendable and retractable ceiling. With the invention, a door-attached pet enclosure apparatus is provided which employs a locking device to lock the pet enclosure in the extended condition. With the invention, a door-attached pet enclosure apparatus is provided which employs a locking device to lock the pet enclosure in the retracted condition.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U. S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

1. A door-attached pet enclosure apparatus, comprising:
a first housing portion attached to a door,
a group of sidewall panels retained in said first housing portion when said apparatus is in a folded-up, storage condition,
a group of roof panels retained in said first housing portion when said apparatus is in the folded-up, storage condition,
a second housing portion attached to said first housing portion, and
roof-to-sidewall securing means for securing said roof panels to said sidewall panels when said apparatus is in an extended, pet-enclosure condition.

2. The apparatus of claim 1 wherein said second housing portion is attached to said first housing portion with a housing-to-housing hinge.

3. The apparatus of claim 1 wherein said sidewall panels are connected to each other with sidewall-panel hinges.

4. The apparatus of claim 1, further including:
housing-to-housing lock means for locking said first housing portion and said second housing portion together when said apparatus is in the folded-up, storage condition.

5. The apparatus of claim 4 wherein said housing-to-housing lock means include:
a first lock member attached to said first housing portion, and
a second lock member attached to said second housing portion.

6. The apparatus of claim 1, further including:
a sidewall-to-sidewall locking means for locking non-hinged ends of sidewall panels together.

7. The apparatus of claim 1 wherein said roof panels are connected to each other with roof-panel hinges.

8. The apparatus of claim 1 wherein:
the door includes a pet access portal,
said first housing portion includes a first housing access portal that is in registration with the pet access portal,
said second housing portion includes a second housing access portal that is in registration with said first housing access portal and the pet access portal when said apparatus is in a folded-up, storage condition.

9. The apparatus of claim 8, further including:
floor-mounted, portal cover gates for covering said second housing access portal when said apparatus is in the extended, pet-enclosure condition.

10. The apparatus of claim 1 wherein said roof-to-sidewall securing means include a lock bar.

11. The apparatus of claim 10 wherein said lock bar is secured at a distal end to a lock loop attached to a distal roof panel.
